(19) United States
(12) Patent Application Publication
(10) Pub. No.: US 2016/0210438 A1
(43) Pub. Date: Jul. 21, 2016

(54) MEDICAL ASSISTANCE DEVICE, CONTROL METHOD FOR MEDICAL ASSISTANCE DEVICE, AND MEDICAL ASSISTANCE SYSTEM

(71) Applicant: FUJIFILM Corporation, Tokyo (JP)

(72) Inventors: Yasunori OHTA, Ashigarakami-gun (JP); Satoshi UEDA, Tokyo (JP); Yuya KUDO, Tokyo (JP); Hironori MATSUMASA, Tokyo (JP)

(73) Assignee: FUJIFILM Corporation, Tokyo (JP)

(21) Appl. No.: 15/080,976

(22) Filed: Mar. 25, 2016

Related U.S. Application Data
(63) Continuation of application No. PCT/JP2014/074386, filed on Sep. 16, 2014.

(30) Foreign Application Priority Data
Sep. 27, 2013 (JP) 2013-202545

(51) Int. Cl. G06F 19/00

(52) U.S. Cl. CPC G06F 19/3456; G06F 19/3487; G06F 19/322

(57) ABSTRACT

A medical assistance device creates a clinical path display screen in which clinical path information including a medical care schedule of a patient, and a graph and a table which are progress information, in which test values of a medical test are displayed along a time axis indicating test date and time of the medical test are displayed. A determination unit determines whether a latest test value of the medical test is within a normal range, sets a time scale for the progress information to a time scale longer than a test interval of the medical test in a case in which the latest test value is within the normal range, switches the progress information to a time scale in which the test interval can be displayed, and displays, on the clinical path display screen, the latest test value and the test value of a plurality of medical tests performed prior to acquisition of the latest test value in a case in which the latest test value is not within the normal range.

### CROSS-REFERENCE TO RELATED APPLICATIONS

This application is a Continuation of PCT International Application No. PCT/JP2014/074386 filed on Sep. 16, 2014, which claims priority under 35 U.S.C §119(a) to Japanese Patent Application No. 2013-202545 filed Sep. 27, 2013. The above application is hereby expressly incorporated by reference, in its entirety, into the present application.

### BACKGROUND OF THE INVENTION

1. Field of the Invention

The present invention relates to a medical assistance device that displays clinical path information of a patient, a control method for the medical assistance device, and a medical assistance system.

2. Description Related to the Prior Art

In recent years, in medical institutions such as hospitals, a clinical path is introduced in order to improve the quality and efficiency of medical care. The clinical path is a medical care schedule table in a chart form that represents standardized medical care content for each disease. Since a plurality of medical care scheduled items such as medical examination, treatment, and test are set along a time axis according to a type of disease in the clinical path in advance, it is possible to simply create a medical care schedule of a patient. Since medical care items necessary for each disease become clear due to the clinical path, the quality and efficiency of the medical care is improved by performing medical care of the patient based on the clinical path. Further, the clinical path is used for confirmation of the medical care scheduled items. In addition, medical care information on specific content, results, or the like of medical examination, treatment, and test performed on the patient is recorded in the clinical path, which is also used for management of medical care record of the patient.

Conventionally, the clinical path is printed on paper to be used. On the other hand, at present, a medical assistance device that enables clinical path information to be viewed using a terminal device such as a personal computer to be easily shared by a plurality of medical staffs such as doctors and nurses is widely known.

WO2005/122033A discloses a general medical information device including a function of creating clinical path information corresponding to a symptom of a patient when a medical inquiry item is selected according the symptom of the patient, and displaying the created clinical path information on a display. Further, this general medical information device includes a function of receiving input of measurement values (hereinafter referred to as vital data) of vital signs, such as a body temperature, a blood pressure, a pulse, and a respiration rate of a patient, and a function of displaying the input vital data on a display so that a change in the vital data can be seen. Accordingly, a medical staff such as a doctor can determine a change in a medical condition of the patient based on the change in the vital data.

JP2012-174080A discloses an invention relating to a terminal device that provides a user interface that can be used to view clinical path information. This terminal device includes a display control unit that generates a display screen in which a user interface is incorporated, a time axis is arranged on a horizontal axis, and a plurality of action items such as medical examination, treatment, and test are arranged on a vertical axis, and displays the display screen on a display. An event mark indicating that a medical action of the action item has been performed at the time indicated on the time axis is displayed at a position at which the time axis on the horizontal axis and the action item on the vertical axis intersect each other. Further, this terminal device includes an event input unit for inputting content of the action which is, for example, a result of the action item when the event mark is displayed on the user interface. For example, if the action item is “measurement of body temperature”, measured “body temperature” is input to the action content. The input action content is displayed along the time axis by the display control unit. The time axis is manually switched between a time scales of “year”, “month”, and “day”.

A medical care schedule of the clinical path is generally used while appropriately changing a medical care scheduled item according to a change in a medical condition of a patient. Therefore, as in WO2005/122033A, displaying test values of medical test performed on the patient at regular test intervals together with the clinical path information is useful in understanding a change in the medical condition of the patient. It is desirable for the test values to be displayed so that progress can be seen along a time axis indicating test date and time of the medical test, such that the change in the medical condition of the patient can be understood. However, if the medical period of the patient is long, an amount of information of the test values to be displayed becomes too large, which may cause important items of the clinical path information to be overlooked. Further, when the medical condition of the patient enters a stable period, test values of the vital data or the like hardly change, and accordingly, it is not necessary for all of test values for a long time to be displayed.

When the function of switching the time scale in JP2012-174080A is used to display the test values, and the time scale of the time axis of the test value is switched to be longer, an amount of information of the test values to be displayed can be reduced. However, when the test value is displayed using the longer time scale, it is difficult for the change in the test value to be understood, and accordingly, the change in the medical condition of the patient is likely to be overlooked.

### SUMMARY OF THE INVENTION

An object of the present invention is to provide a medical assistance device, a control method for the medical assistance device, and a medical assistance system capable of preventing oversight of a change in a medical condition of a patient even when an amount of information of a test value displayed together with clinical path information decreases.

In order to solve the above problem, a medical assistance device of the present invention includes a clinical path information management unit, a medical care information reception unit, a screen creation unit, and a determination unit. The clinical path information management unit manages clinical path information including a medical care schedule of a patient. The medical care information reception unit receives an input of medical care information of the patient including test values of medical test performed on the patient at regular test intervals. The screen creation unit creates a clinical path display screen on which the clinical path information, and progress information including the test values arranged along a time axis indicating test date and time of the medical test are displayed. The determination unit determines whether or not a latest test value of the medical test is within a normal range. The screen creation unit switches a time scale of the progress information according to a result of the determination of the determination unit.

It is preferable that the screen creation unit sets the time scale of the progress information to a time scale longer than the test interval in a case where the latest test value is within the normal range, and switches the time scale of the progress information to a time scale so that the test interval is displayed in a case where the latest test value is not within the normal range, so as to display the latest test value, and test values of a plurality of medical tests performed prior to acquisition of the latest test value on the clinical path display screen.

It is preferable for the screen creation unit to create a graph indicating a temporal transition of the test value as the progress information, and display the graph on the clinical path display screen. It is preferable for the screen creation unit to display the test value together with the graph. It is preferable for the screen creation unit to display, in the graph, a transition of test values of a plurality of types of medical tests.

Further, it is preferable for the screen creation unit to change a display form of the test value in a case where the latest test value is not within a normal range. It is preferable for the screen creation unit to change a display form of text indicating a name of the test value, or a line representing the transition of the test value in the graph in a case where the display form of the test value is changed. Further, the screen creation unit may display a message for informing that the test value is not within the normal range. It is preferable for measurement of vital signs to be performed as the medical test and for vital data to be acquired as the test value.

It is preferable for the clinical path information management unit to at least create and update the clinical path information. Further, it is preferable for the medical assistance device to further include a distribution unit that distributes the clinical path display screen to a client terminal connected over a network.

A control method for a medical assistance device of the present invention creates a clinical path display screen on which clinical path information including a medical care schedule of a patient, and progress information in which test values of medical test performed on the patient at regular test intervals are arranged along a time axis indicating test date and time are displayed. The control method for a medical assistance device includes a medical care information reception step, a determination step, and a time scale switching step. The medical care information reception step receives an input of medical care information of the patient including the test values. The determination step determines whether or not a latest test value of the medical test is within a normal range. The time scale switching step switches a time scale of the progress information according to a result of the determination.

It is preferable for the time scale switching step to set the time scale of the progress information to a time scale longer than the test interval in a case where the latest test value is within the normal range, and switch the time scale of the progress information to a time scale so that the test interval is displayed in a case in where the latest test value is not within the normal range, so as to display the latest test value, and test values of a plurality of medical tests performed prior to acquisition of the latest test value on the clinical path display screen.

A medical assistance system of the present invention includes a medical assistance device, and a client terminal connected to the medical assistance device over a network. The medical assistance device includes a distribution unit that distributes the clinical path display screen to the client terminal, in addition to a clinical path information management unit, a medical care information reception unit, a screen creation unit, and a determination unit.

According to the medical assistance device of the present invention, in a case in which it can be estimated that the latest test value of medical test is within a normal range and a medical condition of the patient is in a stable period, the time scale of the progress information is set to be longer than a test interval of the medical test. Thus, it is possible to reduce an amount of information of the test value. Further, since the time scale of the progress information is switched to a time scale in which the test interval of the medical test can be displayed when the test value is not within the normal range, a variation in the test value can be observed in detail, and the change in the medical condition of the patient can be prevented from being overlooked. Further, since the number of the displayed test values is limited, it is possible to reduce the amount of information of the test value.

### BRIEF DESCRIPTION OF DRAWINGS

For more complete understanding of the present invention, and the advantage thereof, reference is now made to the subsequent descriptions taken in conjunction with the accompanying drawings, in which:

FIG. 1 is a schematic diagram illustrating a configuration of a medical assistance system;

FIG. 2 is a block diagram illustrating a configuration of a medical assistance device;

FIG. 3 is an illustrative diagram illustrating a configuration of a path template information DB;

FIG. 4 is an illustrative diagram illustrating a configuration of a clinical path information DB;

FIG. 5 is a block diagram illustrating a functional configuration of a medical assistance device;

FIG. 6 is an illustrative diagram illustrating a configuration of a clinical path display screen;

FIG. 7 is an illustrative diagram illustrating a configuration of a medical care schedule of the clinical path information;

FIG. 8 is an illustrative diagram of a medical care information input screen;

FIG. 9 is an illustrative diagram illustrating progress information including a graph and a table;

FIG. 10 is an illustrative diagram illustrating a state in which a time scale of the progress information has been switched;

FIG. 11 is an illustrative diagram illustrating a clinical path display screen in which a time scale of a graph and a table has been switched;

FIG. 12 is a flowchart illustrating a procedure of switching the time scale of the graph and the table; and

FIG. 13 is a schematic diagram illustrating a configuration of a medical assistance system in another embodiment of the present invention.

### DESCRIPTION OF THE PREFERRED EMBODIMENTS

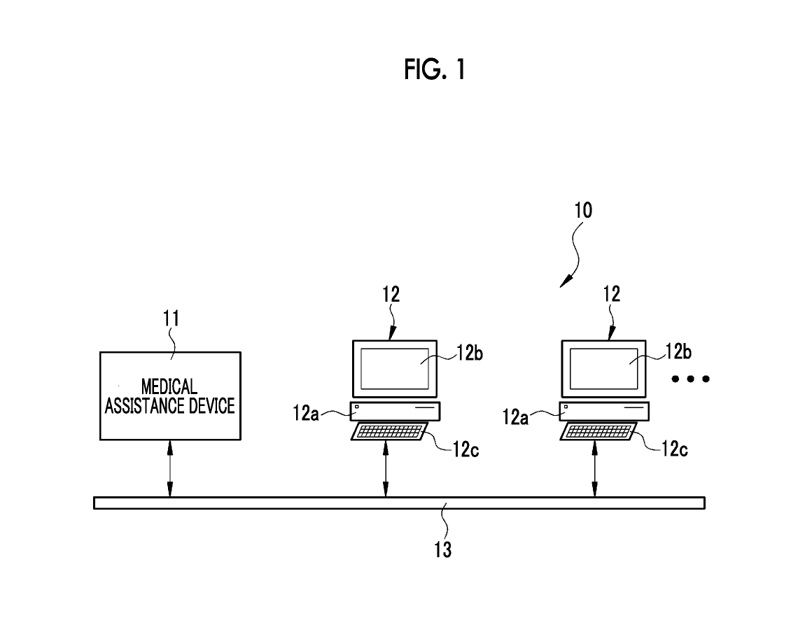

A medical assistance system 10 illustrated in FIG. 1 is a computer system that manages clinical path information so that medical staffs such as doctors and nurses can share the clinical path information. This medical assistance system 10 is installed in a medical institution such as a hospital. The clinical path is a medical care schedule table in a chart form that represents standardized medical care content for each disease. Since a plurality of medical care scheduled items for medical examination, treatment, and test are set in the clinical path along a time axis according to a type of disease in advance, it is possible to easily create a medical care schedule of a patient.

The medical assistance system 10 includes a medical assistance device 11 that manages the clinical path information, and a plurality of client terminals 12 used for, for example, viewing of the clinical path information. The medical assistance device 11 and the client terminals 12 are connected by a network 13 built by an intranet.

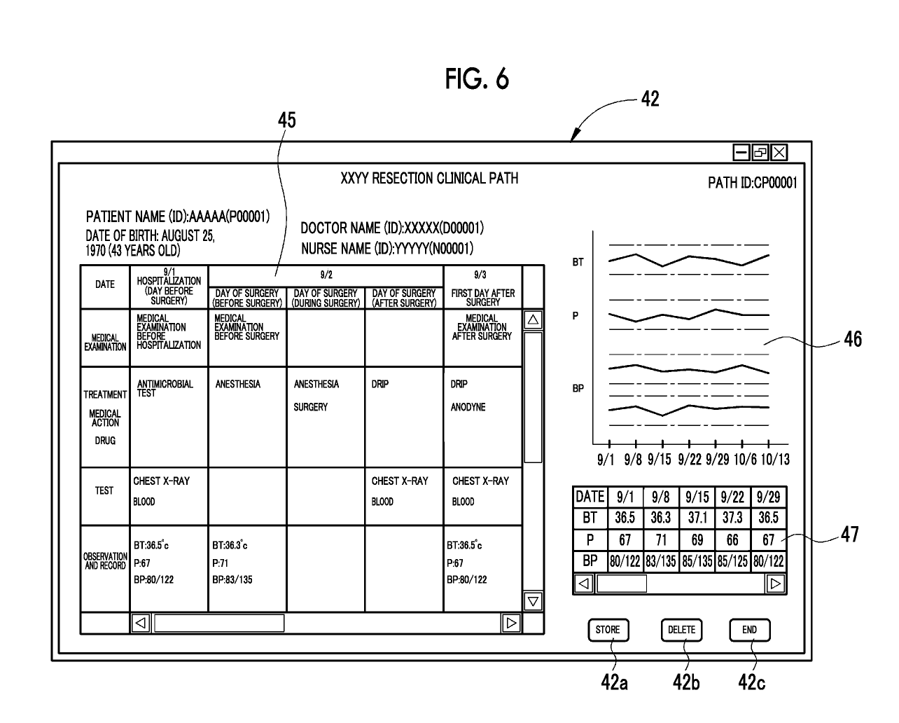

The medical assistance device 11 is, for example, a desktop type personal computer in which an application program for performing management of the clinical path information has been installed. The medical assistance device 11 is installed in, for example, an information processing room of a medical institution. The medical assistance device 11 has a function of receiving login or logout from the client terminal 12, and a function of creating, updating, and deleting the clinical path information in response to a request from the client terminal 12. Further, the medical assistance device 11 has a function of creating a display screen (hereinafter, referred to as clinical path display screen) for displaying the clinical path information on a display 12b of the client terminal 12, and a function of distributing a clinical path display screen 42 (see FIG. 6) to the client terminal 12.

The client terminal 12 is, for example, a desktop type personal computer in which an application program used for viewing of the clinical path information has been installed. A plurality of client terminals 12 are installed, for example, in each medical care department or each medical care room, and are used, for example, for the medical staffs such as doctors and nurses to view the clinical path information. The client terminal 12 includes a terminal body 12a including, for example, a CPU, a memory, and a data storage, a display 12b, and an input device 12c including a mouse or a keyboard. The client terminal 12 includes a function of logging in and out the medical assistance device 11, and a function of requesting the medical assistance device 11 to, for example, create, update, and view the clinical path information. Further, the client terminal 12 includes a function of displaying the clinical path display screen 42 distributed from the medical assistance device 11 on the display 12b, and a function of performing an operation of updating the clinical path information.

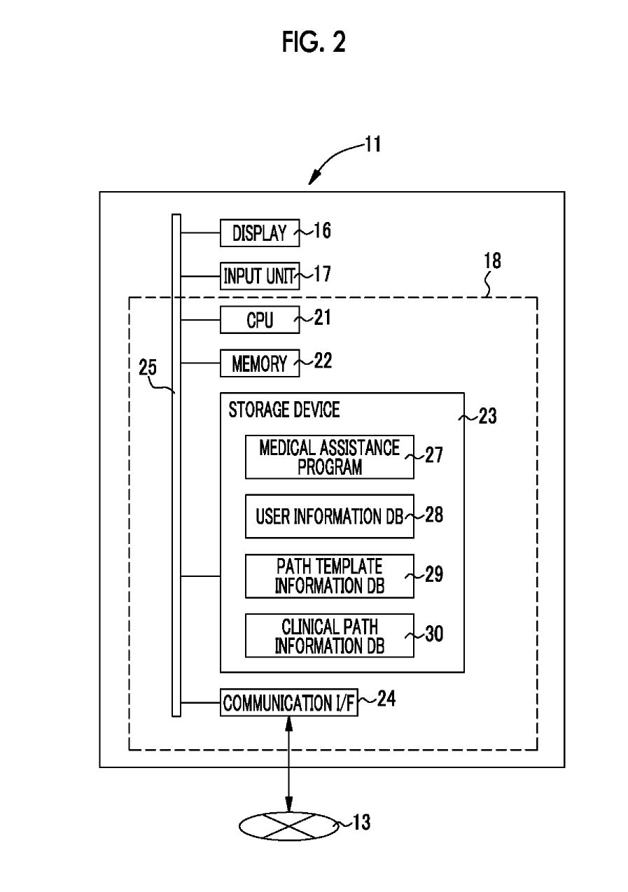

As illustrated in FIG. 2, the medical assistance device 11 is configured based a computer such as a personal computer or a workstation. The medical assistance device 11 includes a display 16, an input unit 17 such as a keyboard and a mouse, and a computer main body 18. A CPU 21, a memory 22, a storage device 23, and a communication I/F 24 are provided in the computer main body 18, and are connected via a data bus 25.

The storage device 23 is a device that stores various data and includes, for example, a hard disk drive. Various programs such as an operating system (not illustrated) or a medical assistance program 27 for causing the computer to function as the medical assistance device 11 are stored in the storage device 23.

Further, various databases such as a user information DB 28, a path template information DB 29, and a clinical path information DB 30 are stored in the storage device 23. The user information DB 28 stores an ID and a password of a user having a right to log in the medical assistance device 11.

The memory 22 is a work memory used for the CPU 21 to execute a process. The CPU 21 loads the operating system stored in the storage device 23 into the memory 22, and executes a process according to the program to generally control each unit of the computer. The communication I/F 24 is a communication interface that connects to the communication network 13 and communicates with each client terminal 12.

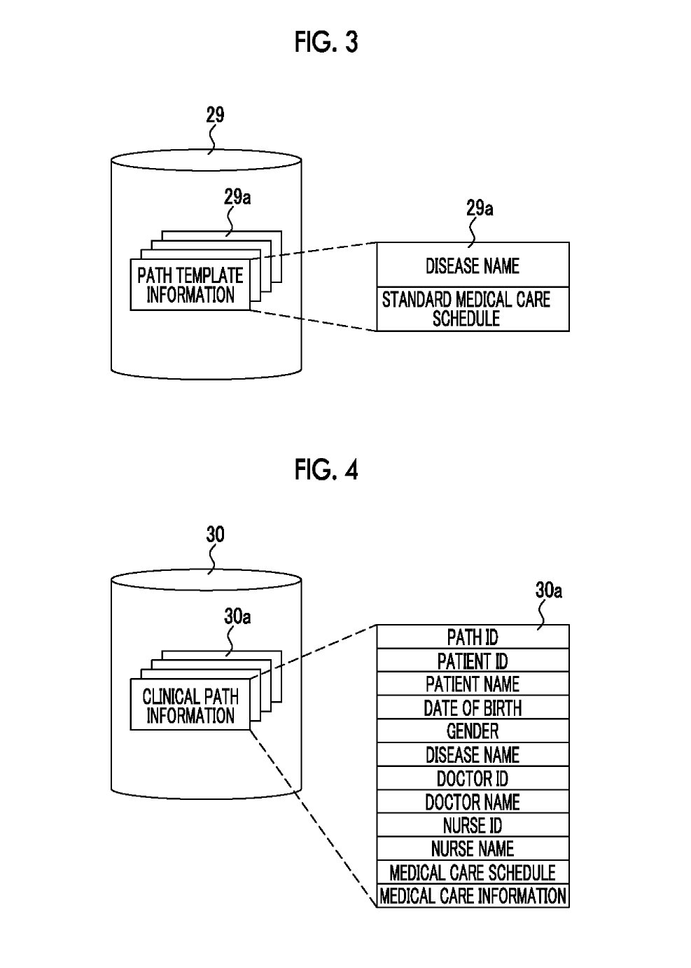

As illustrated in FIG. 3, a plurality of path template information 29a which are templates of the clinical path information are stored in the path template information DB 29. The path template information 29a is, for example, standardized for each disease such as illness or injury, including stroke, cancer, fracture, and burn. A name of the disease, and a standard medical care schedule in which a plurality of medical care scheduled items are set according to a type of disease are stored in the path template information 29a. Path template information of main diseases are prestored in the path template information DB 29, but new path template information may be created and registered by a medical institution in which the medical assistance system 10 is introduced.

As illustrated in FIG. 4, a plurality of clinical path information 30a created for each disease of the patient is stored in the clinical path information DB 30. In the clinical path information 30a, a medical care schedule created based on the standard medical care schedule of the path template information 29a, medical care information on medical care performed on the patient, a path ID for identifying the clinical path information 30a, and patient information, doctor information, and nurses information input at the time of creation of clinical path information 30a are stored. The patient information includes, for example, a patient ID, a patient name, date of birth, a gender, and a disease name. The doctor information is a doctor ID and a doctor name. The nurse information is a nurse ID and a nurse name.

When the clinical path information is created, a patient information DB, a staff information DB, or the like may be stored in the storage device 23 in order to simplify input of patient information or information on staffs such as doctors or nurses. Further, various databases such as the user information DB 28, the path template information DB 29, and the clinical path information DB 30 may be stored in an external data server connected to the medical assistance device 11.

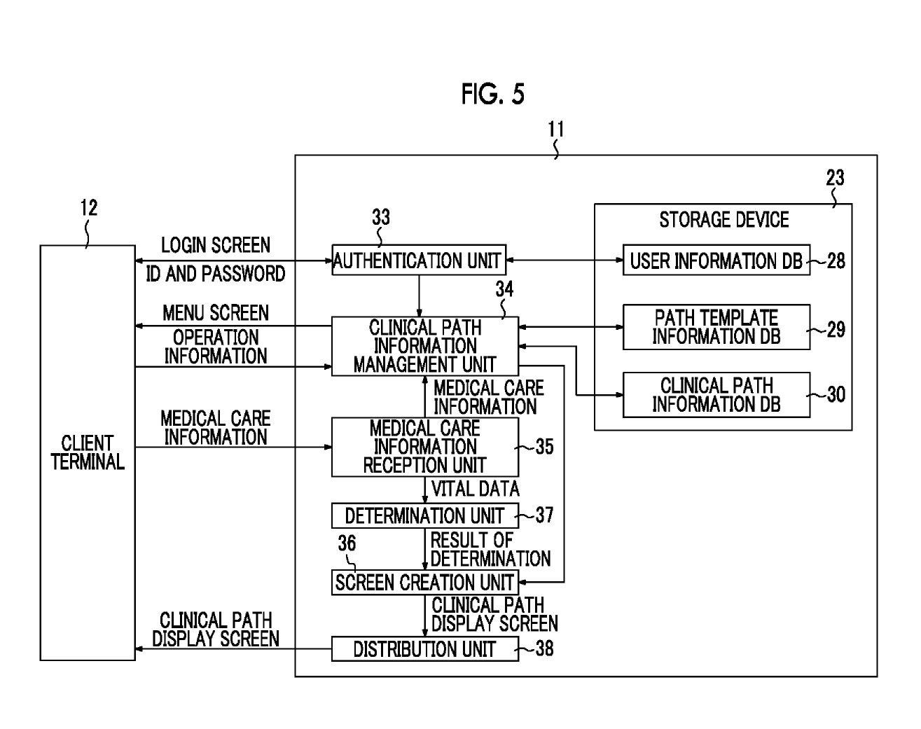

As illustrated in FIG. 5, when the medical assistance program 27 starts up, the CPU 21 of the medical assistance device function as an authentication unit 33, a clinical path information management unit 34, a medical care information reception unit 35, a screen creation unit 36, a determination unit 37, and a distribution unit 38 in cooperation with the memory 22.

The authentication unit 33 performs authentication of a user who logs in by operating the client terminal 12. In a case in which the authentication unit 33 receives a login request from the client terminal 12, the authentication unit 33 distributes a login screen having an input field of a user ID and a user password to the client terminal 12 which is requesting source. The authentication unit 33 determines, through search, whether or not an ID and a password of the user input in the login screen exist in the user information DB 28. The authentication unit 33 authenticates the client terminal 12 in a case in which the input user ID and the user password are found from the user information DB 28, and transmits non-authentication notification without authenticating the client terminal 12 in a case in which the input user ID and the user password are not found from the user information DB 28.

The clinical path information management unit 34 performs management such as creation, updating, and deletion of the clinical path information 30a. The clinical path information management unit 34 distributes a menu screen in which operation buttons such as creation, updating, and deletion button are provided, to the client terminal 12 that has been logged in. In a case in which the menu screen is operated at the client terminal 12, an operation signal indicating content of the operation is input, and the clinical path information management unit 34 performs the management of the clinical path information 30a based on the operation signal.

In a case in which the creation button is operated on the menu screen, the clinical path information management unit 34 distributes a clinical path creation screen to the client terminal 12. Input fields of patient name and ID, date of birth, gender, name of disease, attendant doctor name and ID, attendant nurse name and ID, medical care start date, and the like are provided in the clinical path creation screen. Various information input on the clinical path creation screen is transmitted from the client terminal 12 to the medical assistance device 11 and input to the clinical path information management unit 34. Based on the various input information, the clinical path information management unit 34 creates clinical path information 30a on the basis of the path template information 29a stored in the path template information DB 29. The created clinical path information 30a is stored in the clinical path information DB 30.

Further, in a case in which the updating button is operated in the menu screen, the clinical path information management unit 34 distributes a clinical path updating screen to the client terminal 12. Input fields in which a path ID for identifying the clinical path information 30a, a patient name, a patient ID, an attendant doctor name, an attendant doctor ID, an attendant nurse name, an attendant nurse ID, and the like can be input are provided in the clinical path updating screen. The clinical path information management unit 34 searches for and reads the created clinical path information 30a from the clinical path information DB 30 based on the information input in the clinical path updating screen, and updates the clinical path information 30a in response to the updating operation from the client terminal 12. The updated clinical path information 30a is stored in the clinical path information DB 30.

The medical care information reception unit 35 receives an input of the medical information such as test values of medical examination, medical care, examination, and the like performed on the patient based on the medical care scheduled items of the clinical path information 30a from the client terminal 12. For example, in a case in which the medical care scheduled item is a medical examination or various treatments, a result of the medical examination or a result of the treatments is input as medical information. Further, if medical test periodically performed on the patient exists among the medical care scheduled items, values of the test are periodically input as medical care information. The medical test includes, for example, measurement of vital signs such as a body temperature, a pulse, and a blood pressure. In this case, vital data such as the measured body temperature, pulse, and blood pressure is input as the test values. The received medical information is input to the clinical path information management unit 34 and used to update the clinical path information 30a. Further, the vital data in the medical information received by the medical care information reception unit 35 is input to the determination unit 37.

The screen creation unit 36 creates a clinical path display screen 42 in which a medical care schedule of the clinical path information 30a and progress information indicating test progress of the medical test are displayed so that the clinical path information 30a can be viewed by the client terminal 12. The progress information is information including test date and time and test values of the medical test, and in the present embodiment, the progress information of the vital data is displayed in the clinical path display screen 42.

The determination unit 37 determines whether latest vital data received by the medical care information reception unit 35 is within a normal range in order to determine whether switching of a time scale of the progress information displayed in the clinical path display screen 42 is necessary. Specifically, upper and lower limits are prestored as values of the normal range of the vital data such as a body temperature, a pulse, and a blood pressure in the storage device 23, the determination unit 37 compares the value of the normal range with the latest vital data, and determines that the vital data is not within the normal range in a case in which the vital data exceeds the upper limit or in a case in which the vital data is smaller than the lower limit. The determination result of the vital data is input to the screen creation unit 36.

The screen creation unit 36 switches the time scale of the progress information displayed in the clinical path display screen 42 according to a result of the determination of the determination unit 37. Specifically, in a case in which the latest vital data is within the normal range, the screen creation unit 36 sets the time scale of the progress information to a time scale longer than an test interval of the medical test, that is, a measurement interval of the vital data. Further, in a case in which the latest vital data is not within the normal range, the screen creation unit 36 switches the time scale of the progress information to a time scale enabling the measurement interval of the vital data to be displayed, and displays the latest vital data and vital data measured a plurality of times prior to the latest vital data on the clinical path display screen 42.

The distribution unit 38 distributes the clinical path display screen 42 created by the screen creation unit 36 to the client terminal 12 logged in the medical assistance device 11 over the network 13. For example, in a case in which the same clinical path information 30a is viewed by a plurality of client terminals 12, the distribution unit 38 distributes the same clinical path display screen 42 to the respective client terminals 12. Further, in a case in which different clinical path information 30a are viewed by a plurality of client terminals 12, the distribution unit 38 distributes different clinical path display screens 42 to the respective client terminals 12.

As illustrated in FIG. 6, a medical care schedule table 45 created on the basis of the medical care schedule of the clinical path information 30a, and a graph 46 and a table 47 of the vital data which are the progress information of the medical test are displayed in the clinical path display screen 42. The path ID for identifying the clinical path information 30a, the patient name and ID, date of birth of the patient, the attendant doctor name and ID, and the attendant nurse name and ID are displayed in an upper portion of the clinical path display screen 42. The clinical path display screen 42 is operated by the input device 12c of the client terminal 12.

A storage button 42a, a deletion button 42b, and an end button 42c are provided in a lower right portion of the clinical path display screen 42. The storage button 42a is operated in a case in which the clinical path information 30a displayed in the clinical path display screen 42 is stored in the clinical path information DB 30. The deletion button 42b is operated in a case in which the clinical path information 30a displayed in the clinical path display screen 42 is not stored or in a case in which the clinical path information 30a is deleted from the clinical path information DB 30. The end button 42c is operated in a case in which the creation, updating, or viewing of the clinical path information 30a in the clinical path display screen 42 ends.

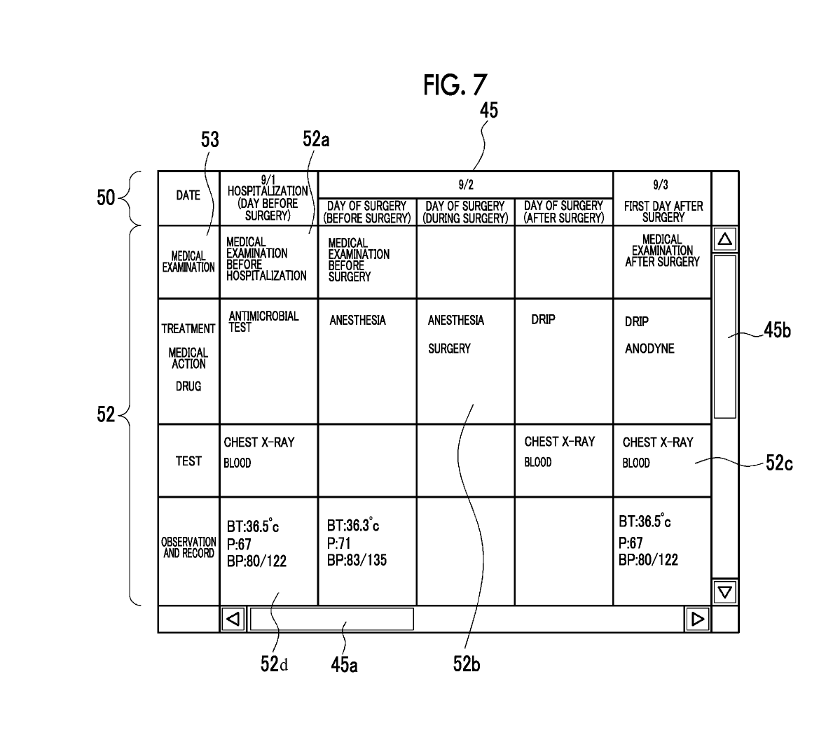

As illustrated in FIG. 7, a medical care schedule table 45 is an example of the clinical path used for a resection to reset, for example, a portion of an organ such as a stomach or a lung using a laparoscope, a thoracoscope, or the like. The medical care schedule table 45 is a schedule table in a chart form in which a plurality of medical care scheduled items are arranged along a time axis arranged on a horizontal axis. A plurality of date fields 50 in which date on which the medical care of the patient is performed and a medical care situation of the patient on that date are recorded are provided in the time axis. The medical care situation represents the progress of the medical care, such as “hospitalization (day before surgery)”, “day of surgery (before surgery)”, “day of surgery (during surgery)”, “day of surgery (after surgery),” “N number of days after surgery”, and “hospital discharge”.

Under the date field 50, a plurality of scheduled item fields 52 are provided in which medical care scheduled items set for each disease according to the standard medical care schedule of the path template information 29a are displayed. The scheduled item fields 52 are divided into, for example, a plurality of medical care items such as “medical examination”, “treatment, medical action, and drug”, “test”, and “observation and record”, as illustrated in a plurality of heading fields 53 to the left. For example, the medical care scheduled item “medical examination before hospitalization” is displayed in a scheduled item field 52a corresponding to the medical care situation “hospitalization (day before surgery)” and the medical care item “medical examination”. Further, the medical care scheduled item “anesthesia and surgery” is displayed in a scheduled item field 52b corresponding to the medical care situation “day of surgery (during surgery)” and the medical care item “treatment, medical action, and drug”. The medical care scheduled item “chest X-ray and blood” is displayed in a scheduled item field 52c corresponding to the medical care situation “first day after surgery” and the medical care item “test”.

Items such as a body temperature (BT), a pulse (P), and a blood pressure (BP) are displayed in each scheduled item field corresponding to “observation and record” of the medical care item in order to represent measurement of vital signs. In this medical care schedule table 45, since the item of the vital data is displayed in each medical care date, the measurement interval of the vital data becomes daily. In FIG. 7, the vital data is displayed in the scheduled item field 52d, but only the items BT, P, and BP are displayed until the vital data is input from the client terminal 12.

Since the medical care scheduled item of the medical care schedule table 45 can be scrolled in a horizontal direction due to a scroll bar 45a provided in a lower portion, it is possible to cope with disease with a large number of medical care days. Accordingly, although only “first day after surgery” is drawn in FIG. 7, “hospital discharge” can also be viewed by scrolling the medical care schedule table 45.

Further, since the medical care scheduled item of the medical care schedule table 45 can be scrolled in a vertical direction due to a scroll bar 45b provided at a right end, it is possible to cope with disease with a large number of medical care items. Therefore, in a case in which there is a further scheduled item field under “observation and record”, all of the scheduled item fields can be viewed by scrolling the medical care schedule table 45.

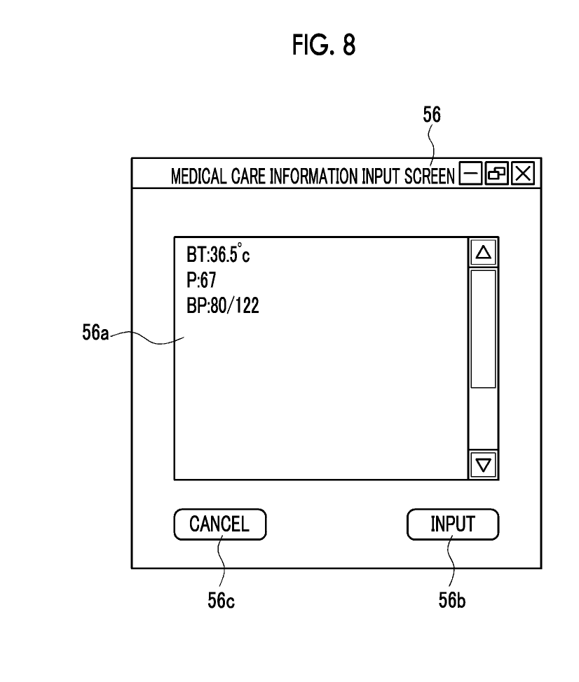

The medical care information can be input from the client terminal 12 in each medical care scheduled item of the medical care schedule table 45. For example, when the scheduled item field 52d is selected by the input device 12c of the client terminal 12, the medical care information input screen 56 (see FIG. 8) is displayed on the clinical path display screen 42.

As illustrated in FIG. 8, an input field 56a to which the medical care information is input, an input button 56b for instructing input execution, and a cancel button 56c for instructing input stop are provided in the medical care information input screen 56. Since the medical care scheduled item “BT:, P:, BP” already displayed in the selected scheduled item field 52a is displayed in the input field 56a, the vital data can be input to correspond to this medical care scheduled item. Further, the medical care scheduled item first displayed in the scheduled item field may be deleted or rewritten. The medical care information input to the input field 56a is transmitted to the medical assistance device 11 over the network 13 by the operation of the input button 56b. The medical care information transmitted to the medical assistance device 11 is received by the medical care information reception unit 35. Further, since the input of the medical care information is similarly performed in the respective scheduled item fields “medical examination”, “treatment, medical action, and drug”, and “test”, detailed description will be omitted.

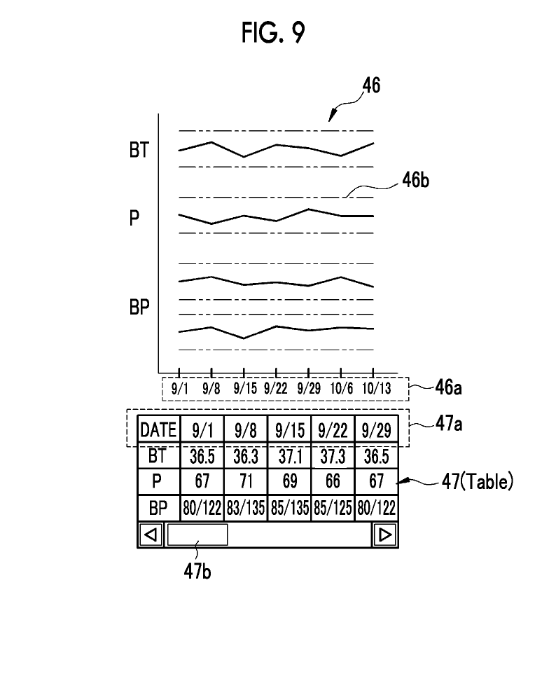

As illustrated in FIG. 9, the graph 46 of the vital data is a line graph in which a time axis 46a representing measurement date of the vital data is arranged on a horizontal axis, and the value of the vital data is arranged on a vertical axis. In the graph 46, values of body temperature (BT), a pulse (P), and a blood pressure (BP) are plotted from the top. Range lines 46b indicating values in a normal range are shown by an alternate long and short dash line over and under the vital data. The graph 46 shows only the vital data of a plurality of tests in order to reduce a display space within the clinical path display screen 42. This graph 46 is created based on the vital data input to the “observation and record” of the medical care schedule table 45.

In the table 47 of the vital data, the values of the body temperature (BT), the pulse (P), and the blood pressure (BP) are described to correspond to the time axis 47a representing the measurement time of the vital data. The table 47 shows only the vital data of a plurality of tests in order to reduce a display space. In a lower portion of the table 47, a scroll bar 47b for scrolling the table 47 in a horizontal direction is provided such that vital data that has not been displayed can be displayed. This table 47 is created based on the vital data input to the “observation and record” of the medical care schedule table 45, similar to the graph 46.

In a case in which latest vital data on October 13 is within the normal range, the screen creation unit 36 sets the time axes 46a and 47a of the graph 46 and the table 47 to a time scale longer than daily which is the measurement interval of the vital data, such as every other week, and displays a representative value on every other week in the graph 46 and the table 47. Accordingly, in a case in which it can be estimated that the vital data is within the normal range and the medical condition of the patient is in a stable period, it is possible to reduce an amount of information of the vital data. Further, the amount of information of the vital data is reduced, but it is possible to recognize a change in the medical condition of the patient in an entire medical care period since the vital data from the time of start of the measurement to a current time is displayed.

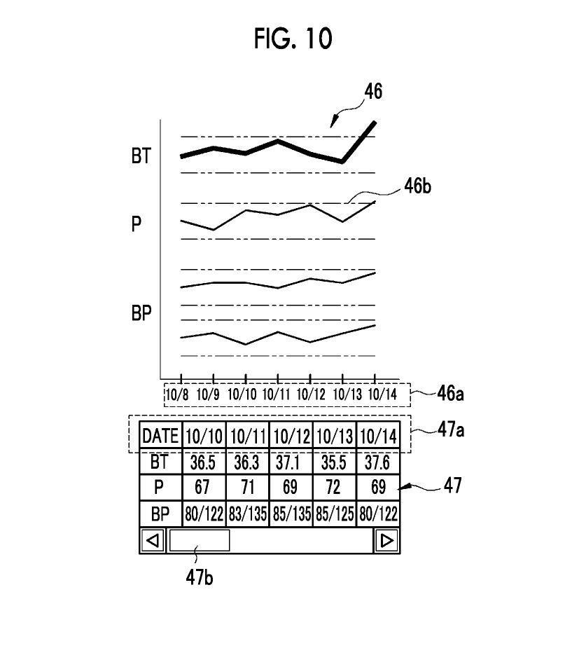

As illustrated in FIG. 10, in a case in which the latest vital data on October 14 is not in the normal range, the screen creation unit 36 switches the time axes 46a and 47a of the graph 46 and the table 47 to a time scale in which the measurement interval of the vital data can be displayed, for example, daily which is a measurement interval of the vital data. Further, the latest vital data, and vital data of measured a plurality of times prior to the latest vital data are displayed in the graph 46 and the table 47. In the example illustrated in FIG. 10, an test value of BT on October 14 exceeds the normal range, and test values before October 14 such as test values of October 8 to October 13 are displayed. Accordingly, in a case in which the vital data is not within the normal range, a variation in the vital data can be observed in detail, and thus, it is possible to prevent oversight of a change in medical condition of the patient. Further, since the number of vital data to be displayed is limited, it is possible to reduce an amount of information of the vital data.

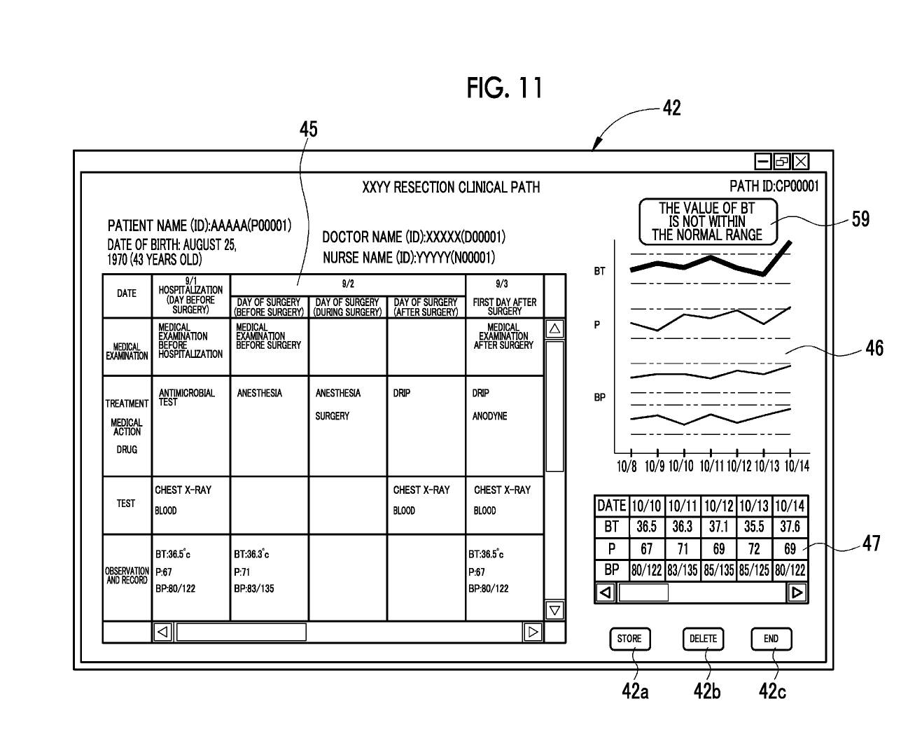

In a case in which the vital data is not within the normal range, the screen creation unit 36 changes a display form of the vital data in order to prompt the medical staffs to give attention to the vital data. Specifically, the screen creation unit 36 thickens a line of the graph of the vital data not within the normal range as compared to the line of the graph of the vital data within the normal range. Examples of changing the display mode may include changing color of a line or characters of a name of the vital data, or changing a font of the characters. In the example illustrated in FIG. 10, a line of a graph of BT is thickened. Further, as illustrated in FIG. 11, in a case in which the latest vital data is not within the normal range, a message 59 such as “the value of **** is not within the normal range” may be displayed in an upper portion of the graph 46. A type of vital data not within the normal range is described in “****” of the message 59.

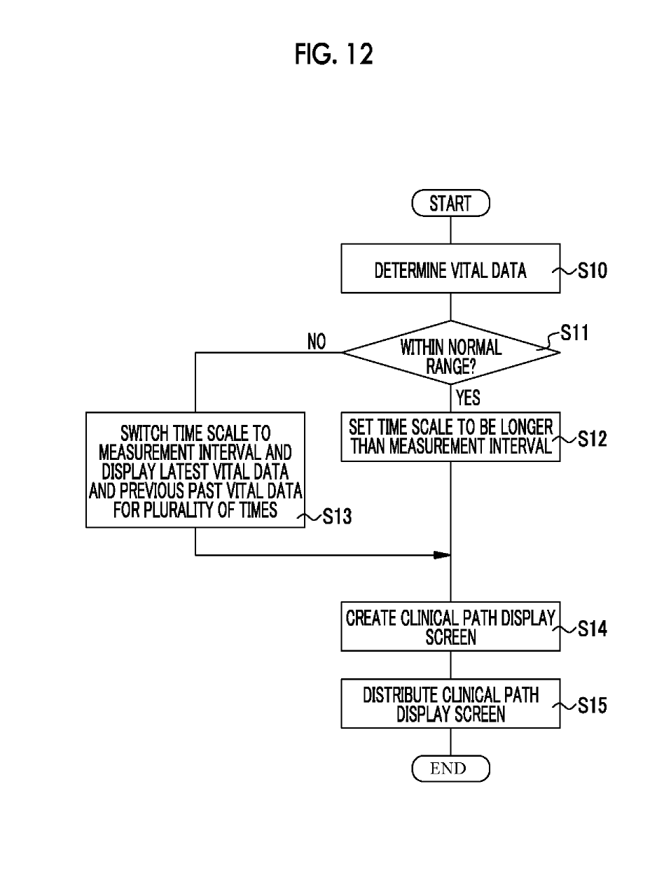

Next, an operation of the above embodiment will be described with reference to FIG. 12. The medical assistance device 11 creates the clinical path information 30a using the clinical path information management unit 34 in response to a creation request from the client terminal 12. The screen creation unit 36 creates the clinical path display screen 42 in which the created clinical path information 30a is displayed. The distribution unit 38 distributes the created clinical path display screen 42 to the client terminal 12.

The client terminal 12 displays the distributed clinical path display screen 42 on the display 12b. When an operation of inputting the medical care information to the scheduled item field 52 of the medical care schedule table 45 is performed by the client terminal 12, the medical care information including vital data is transmitted from the client terminal 12 to the medical assistance device 11. The medical care information reception unit 35 receives the transmitted medical care information and inputs the medical care information to the clinical path information management unit 34. The clinical path information management unit 34 inputs the medical care information to the clinical path information 30a. Further, the medical care information reception unit 35 inputs the vital data in the transmitted medical care information to the determination unit 37.

The determination unit 37 compares the latest vital data received by the medical care information reception unit 35 with the prestored value of the normal range of the vital data, and determines whether or not the latest vital data is within the normal range (S10).

In a case in which the latest vital data is within the normal range (YES in S11), the screen creation unit 36 switches time axes 46a and 47a of the graph 46 and the table 47 to a time scale longer than the measurement interval of the vital data, so that representative values at constant time intervals are displayed in the graph 46 and the table 47 (S12).

Further, in a case in which the latest vital data is not within the normal range (NO in S11), the screen creation unit 36 switches the time scale of the time axes 46a and 47a of the graph 46 and the table 47 to the measurement interval of the vital data, so that the latest vital data and past vital data measured a plurality of times prior to the latest vital data are displayed in the graph 46 and the table 47 (S13).

The screen creation unit 36 creates the clinical path display screen 42 in the time scale switched according to a result of the determination of the determination unit 37 (S14), and the distribution unit 38 distributes the created clinical path display screen 42 to the client terminal 12 (S15).

Further, the medical assistance device 11 reads the created clinical path information 30a from the clinical path information DB 30 in response to a request from the client terminal 12, and distributes the clinical path display screen 42 created on the basis of the read clinical path information 30a to the client terminal 12. In this case, the determination unit 37 determines the latest vital data input to the read clinical path information 30a, and the screen creation unit 36 switches the time scale of the graph 46 and the table 47 according to a result of the determination.

According to the above embodiment, in a case in which it can be estimated that the vital data is within a normal range and the medical condition of the patient is in the stable period, the time scale of the time axis of the vital data is longer than the measurement intervals. Thus, it is possible to reduce an amount of information of the vital data. Further, although the amount of information of the vital data is smaller, the vital data from the time of the start of the measurement to the present time is displayed, and accordingly, it is possible to recognize the change in the medical condition of the patient in an entire medical care period. Further, since the time scale of the time axis of the vital data is switched to a time scale in which the measurement interval can be displayed in a case in which the vital data is not within the normal range, a variation in the vital data can be observed in detail, and the change in the medical condition of the patient can be prevented from being overlooked. Further, since the number of pieces of the vital data to be displayed is limited, it is possible to reduce the amount of information of the vital data.

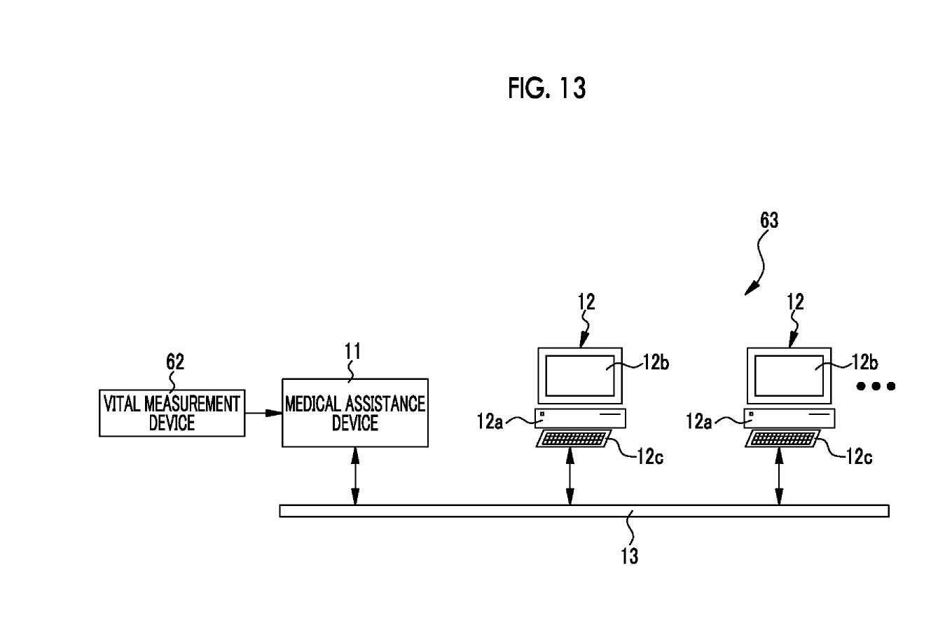

While the example in which the vital data is input from the client terminal 12 to the medical assistance device 11 has been described in the above embodiment, the vital data may be directly input from a vital measurement device 62 such as a biological monitor to the medical assistance device 11, and the clinical path display screen 42 may be created based on this vital data, as illustrated in FIG. 13. In this case, the medical assistance system 63 of the present invention includes the medical assistance device 11, the client terminal 12, and the vital measurement device 62.

Further, while the example in which the time scale of the vital data is switched between daily and every other week has been described in the above embodiment, the time scale is not limited thereto. For example, a medical care period or vital data measurement intervals are significantly different according to a difference between medical care forms such as a type of disease or a medical condition, hospitalization, hospital visit, and home healthcare, it is desirable for the time scale to be appropriately set according to a medical care period and measurement intervals.

Further, while the measurement of the vital data as the medical test and the test values has been described by way of example, the present invention can be applied to medical test periodically performed on the patient through which test values available for recognition of a medical condition of the patient, such as a test value of blood test and test values of various tissue tests, are obtained.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical assistance device comprising:
a clinical path information management unit that manages clinical path information including a medical care schedule of a patient;
a medical care information reception unit that receives an input of medical care information of the patient including test values of medical test performed on the patient at regular test intervals;
a screen creation unit that creates a clinical path display screen, on which the clinical path information, and progress information including the test values arranged along a time axis indicating test date and time of the medical test are displayed; and
a determination unit that determines whether or not a latest test value of the medical test is within a normal range,
wherein the screen creation unit switches a time scale of the progress information according to a result of the determination of the determination unit.

2. The medical assistance device according to claim 1, wherein the screen creation unit sets the time scale of the progress information to a time scale longer than the test interval in a case where the latest test value is within the normal range, and switches the time scale of the progress information to a time scale so that the test interval is displayed in a case where the latest test value is not within the normal range, so as to display the latest test value, and test values of a plurality of medical tests performed prior to acquisition of the latest test value on the clinical path display screen.

3. The medical assistance device according to claim 2,
wherein the screen creation unit creates a graph indicating a temporal transition of the test value as the progress information, and displays the graph on the clinical path display screen.

4. The medical assistance device according to claim 3,
wherein the screen creation unit displays the test value together with the graph.

5. The medical assistance device according to claim 4,
wherein the screen creation unit displays, in the graph, a transition of test values of a plurality of types of medical tests.

6. The medical assistance device according to claim 4,
wherein the screen creation unit changes a display form of the test value in a case where the latest test value is not within a normal range.

7. The medical assistance device according to claim 6,
wherein the screen creation unit changes a display form of text indicating a name of the test value, or a line representing the transition of the test value in the graph.

8. The medical assistance device according to claim 6,
wherein the screen creation unit displays a message for informing that the test value is not within the normal range.

9. The medical assistance device according to claim 1,
wherein the medical test is measurement of vital signs, and the test value is vital data.

10. The medical assistance device according to claim 1,
wherein the clinical path information management unit at least creates and updates the clinical path information.

11. The medical assistance device according to claim 1, further comprising a distribution unit that distributes the clinical path display screen to a client terminal connected over a network.

12. A control method for a medical assistance device that creates a clinical path display screen on which clinical path information including a medical care schedule of a patient, and progress information in which test values of medical test performed on the patient at regular test intervals are arranged along a time axis indicating test date and time are displayed, the control method comprising:
a medical care information reception step of receiving an input of medical care information of the patient including the test values;
a determination step of determining whether or not a latest test value of the medical test is within a normal range; and
a time scale switching step of switching a time scale of the progress information according to a result of the determination.

13. The control method for a medical assistance device according to claim 12,
wherein the time scale switching step sets the time scale of the progress information to a time scale longer than the test interval in a case where the latest test value is within the normal range, and switches the time scale of the progress information to a time scale so that the test interval is displayed in a case where the latest test value is not within the normal range, so as to display the latest test value, and test values of a plurality of medical tests performed prior to acquisition of the latest test value on the clinical path display screen.

14. A medical assistance system including a medical assistance device that manages clinical path information including a medical care schedule of a patient, and a client terminal connected to the medical assistance device over a network, the medical assistance device comprising:
a medical care information reception unit that receives an input of medical care information of the patient including test values of medical test performed on the patient at regular test intervals from the client terminal;
a screen creation unit that creates a clinical path display screen on which the clinical path information, and progress information including the test values arranged along a time axis indicating test date and time of the medical test are displayed;
a distribution unit that distributes the clinical path display screen to the client terminal; and
a determination unit that determines whether or not a latest test value of the medical test is within a normal range,
the screen creation unit switches a time scale of the progress information according to a result of the determination of the determination unit.

15. The medical assistance system according to claim 14, wherein the screen creation unit sets the time scale of the progress information to a time scale longer than the test interval in a case where the latest test value is within the normal range, and switches the time scale of the progress information to a time scale so that the test interval is displayed in a case where the latest test value is not within the normal range, so as to display the latest test value, and test values of a plurality of medical tests performed prior to acquisition of the latest test value on the clinical path display screen.
